(19) United States
(12) Patent Application Publication
(10) Pub. No.: US 2012/0188376 A1
(43) Pub. Date: Jul. 26, 2012

(54) SYSTEM AND METHOD FOR ACTIVATING CAMERA SYSTEMS AND SELF BROADCASTING

(75) Inventors: Adi Chatow, Palo Alto, CA (US); Igal Yaari, Palo Alto, CA (US); Tom Blair, San Francisco, CA (US)

(73) Assignee: FLYVIE, INC., Palo Alto, CA (US)

(21) Appl. No.: 13/356,899

(22) Filed: Jan. 24, 2012

Related U.S. Application Data
(60) Provisional application No. 61/436,106, filed on Jan. 25, 2011.

(51) Int. Cl. H04N 7/18; G08G 1/01

(52) U.S. Cl. 348/148; 340/936; 348/E07.085

(57) ABSTRACT

A system for monitoring the operation of a vehicle. The system comprises a plurality of sensors; a plurality of optical capture devices; a memory in which at least a recording schema is stored, the at least recording schema contains rules for operation of at least one of the plurality of optical capture devices responsive of at least one of the plurality of sensors respective of at least one activity to be captured; and a recorder coupled to the plurality of sensors, the plurality of optical capture devices and the memory, the recorder determines based on the at least recording schema and responsive of at least an input from at least one of the plurality of sensors which of the at least one of the plurality of optical capture devices to operate.

### CROSS REFERENCE TO RELATED APPLICATIONS

This application claims the benefit of U.S. provisional application No. 61/436,106 filed on Jan. 25, 2011, the contents of which are herein incorporated by reference.

### TECHNICAL FIELD

The present invention relates generally to solutions for activation of video recording based on sensors inputs and for broadcasting of recorded video.

### BACKGROUND OF THE INVENTION

Systems for recording operation of a vehicle or a person operating a vehicle typically include an array of cameras, an array of sensors, and a storage for storing the recorded data. In one implementation of such systems, the cameras always record the data and the recorded data is saved together with the sensor's information. The content saved in the storage is analyzed off-line by a person, to detect events that may have caused, for example, a road accident.

In another implementation of such a vehicle recording system, the recording is managed by a central element that determines, based on the sensors' inputs, when to retrieve content from the cameras. The retrieved content is collected by the central element and then sent to a remote location for analysis. The disadvantage of such a system is that while the central element retrieves data from the cameras its stops the monitoring of the sensors, thus valuable information may not be gathered. As a result, such a system typically includes only one sensor being monitored by the central element. Furthermore, the conventional vehicle recording system is limited to determine when to collect video information from the cameras. Any missing information that was not previously collected cannot be available for the off-line analysis.

As a result, the conventional vehicle recording systems are limited to applications related to road accidents or safety of a car driver. Furthermore, due to lack of detailed information recorded during the operation of the vehicle, the recorded information is analyzed by people who are uniquely trained for such tasks.

It would be therefore advantageous to provide a solution to overcome the deficiencies of conventional vehicle recording systems.

### SUMMARY OF THE INVENTION

Certain embodiments include herein include a system for monitoring the operation of a vehicle. The system comprises a plurality of sensors; a plurality of optical capture devices; a memory in which at least a recording schema is stored, the at least recording schema contains rules for operation of at least one of the plurality of optical capture devices responsive of at least one of the plurality of sensors respective of at least one activity to be captured; and a recorder coupled to the plurality of sensors, the plurality of optical capture devices and the memory, the recorder determines based on the at least recording schema and responsive of at least an input from at least one of the plurality of sensors which of the at least one of the plurality of optical capture devices to operate.

Certain embodiments include herein include a method for determining operation of a plurality of optical capturing devices mounted on a vehicle. The method comprises receiving sensory inputs from a plurality of sensors mounted on the vehicle; determining which of a plurality of recording schemas stored in memory are to be activated responsive to at least an input from the sensory inputs; operating at least an optical capturing device based at least on a determined recording schema from the plurality of recording schemas, wherein a recoding schema contains rules for operation of at least one of the plurality of optical capture devices responsive of at least one of the plurality of sensors respective of at least one activity to be captured; and recording at least an information segment by the at least an optical capturing device responsive of the determined schema.

### BRIEF DESCRIPTION OF THE DRAWINGS

The subject matter that is regarded as the invention is particularly pointed out and distinctly claimed in the claims at the conclusion of the specification. The foregoing and other features and advantages of the invention will be apparent from the following detailed description taken in conjunction with the accompanying drawings.

FIG. 1 is a diagram of a vehicle recording system utilized according to an embodiment of the invention.

FIG. 2 is a flowchart of the operation of the vehicle recording system according to an embodiment of the invention.

### DETAILED DESCRIPTION OF THE INVENTION

It is important to note that the embodiments disclosed are only examples of the many advantageous uses of the innovative teachings herein. In general, statements made in the specification of the present disclosure do not necessarily limit any of the various claimed inventions. Moreover, some statements may apply to some inventive features but not to others. In general, unless otherwise indicated, singular elements may be in plural and vice versa with no loss of generality. In the drawings, like numerals refer to like parts through several views.

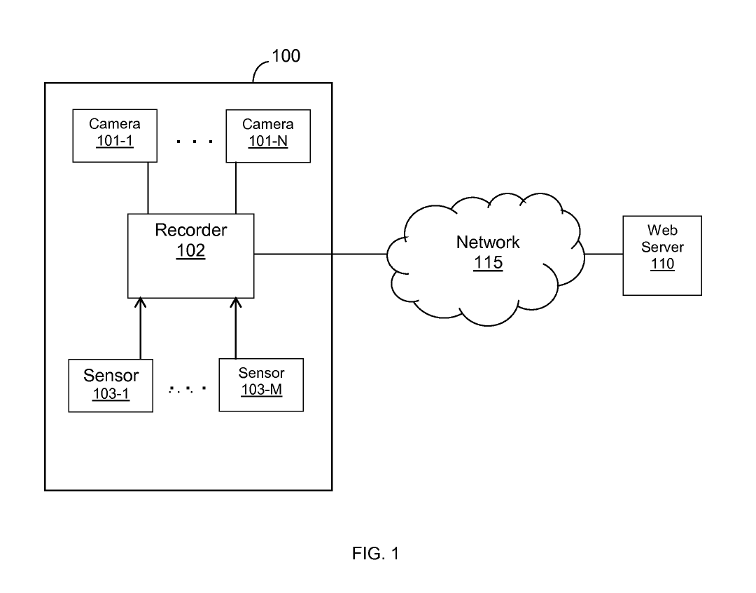

FIG. 1 is an exemplary and non-limiting diagram of a vehicle recording system 100 utilized according to certain embodiments of the invention. The components of the system 100 can be installed in a vehicle, motorized or non-motorized, that may include, but is not limited to, a plane, a truck, a car, a glider, a boat, a snowmobile, a helicopter, a motor cycle, bicycle and the like. In an embodiment, the vehicle can be a motorized machine utilized in sport activity, for example, a racing car, a racing boat, and the like.

As will be described in detail below, the data recorded by the system 100 can be utilized in many applications including, for example, flight emulation, training of a person operating the vehicle (e.g., pilots, skippers, car drivers, truck drivers, racing car drivers, and so on), detection of drivers fatigue, monitoring and alerting of medical conditions of a person operating the vehicle or thereon, tracking supply chains, and so on.

As depicted in FIG. 1, the vehicle recording system 100 that records data respective of activities that are of interest to a user of the system 100. In an embodiment, the system 100 communicates with a web server 110 over a network 115. The web server 110 receives the recorded content, or portion thereof, and enables a user to view the recorded content through a user interface (e.g., a web browser) or share the recorded content with other users, by uploading the recorded content to, for example, social media websites or video sharing websites. Therefore, the disclosed system automatically broadcasts the recorded information. As will be described below certain segments of the recorded content is broadcast, where such segments are determined based, in part, on sensory inputs received during the recording of each of the segments. The user may preconfigure the web server 110 with a list of web-sites that the segments can be uploaded to. The network 115 may be a local area network (LAN), a wireless LAN (WLAN), wide area network (WAN), the Internet, the like, or combinations thereof.

The vehicle recording system 100 captures visual data, audio data, and motion data based on one or more recording schemas and the state of one or more of sensors. As shown in FIG. 1, the vehicle recording system 100 includes a plurality of cameras 101-1 through 101-N (collectively referred to as cameras 101) connected to a recorder 102, and a plurality of sensors 103-1 through 103-M (collectively referred to as sensors 103).

The cameras 101 capture visual (images and video data) and audio and are operated under the control of the recorder 102. The cameras 101 may include, but are not limited to, video cameras, stills cameras, Infrared cameras, smart phones, or any computing device having a built-in optical capture device to which the recorder 102 can interface with. The cameras 101 may be mounted in various places inside and/or outside the vehicle, either permanently or temporarily. A camera 101 can also include an audio capturing device that captures, for example, the plane radio, intercom audio and cockpit audio.

The sensors 103 may include, but are not limited to, accelerometer (or any type other motion sensor), a GPS (or any other type of a position sensor), heart rate, temperature, instrumentation sensors (e.g., revolutions per minute (RPM), engine status, tire pressure, etc.), a gyro, a compass, and so on. The recorder 102 includes a processor and internal memory (not shown) configured to perform the recording process as will be described below. The recorder 102 also includes a removable media card, e.g., a flash memory card (not shown in FIG. 1) or embedded flash media, on which data captured by the cameras 101 is saved, in addition to one or more recording schemas. The cameras 101 and sensors 103 are connected to the recorder 102 through a wire connection, a wireless connection, or combination thereof. Such connections may be facilitated using communication protocols including, for example, a USB, a PCIe bus, an HDMI, a WLAN, Bluetooth, ZigBee, RGB, and the like.

The recorder 102 includes a network interface (not shown) to interface with the network 115. A user can access the recorder 102 through a user interface (e.g., a web browser) to control the configuration of the recorder 102 and/or to upload and/or modify the recordering schemas. In one embodiment, the recorder 102 may be realized in a computing device including, for example, a personal computer, a smart phone, a tablet computer, a laptop computer, and the like.

According certain embodiments disclosed herein, the recorder 102 controls each of the cameras 101 based on the inputs received from the plurality of sensors 103 and at least one recording schema. That is, the recorder 102 can instruct each of the cameras 101 to start/stop capturing visual/audio data, change the zoom and/or view angle, resolution, shutter speed, frame rate of the captured video signal, optical configurations, and so on. This can be useful, for example and without limitation, when the sensory input indication is of an event from a particular area around or inside the vehicle. An emphasis of recording can then be determined by the recorder 102, so as to cause the cameras 101 to adapt for recording that best suits the event detected by the sensors 103.

In an embodiment of, a recording schema defines segments that should be recorded during the operation of the vehicle. Specifically, for each segment the recording schema defines one or more sensors' inputs that triggers the beginning and the end of the recording, one or more cameras 101 that should capture the visual/audio data, and the state (e.g., zoom, frame rate, angle view, etc.) of each such camera. The setting of each segment is based on the activity that should be captured. The recording schema can also define which of the segments should be tagged as “high interest”. Such “high interest” segments can be then uploaded, preferably in real-time or near real-time, by the web server 110 or the recorder 102 to video-sharing web sites and/or social media web sites, and the like. A recording schema includes rules defining the operation of each of the cameras 101 responsive of sensory inputs from the one or more of the sensors 103. A recording schema is associated with a certain activity to be captured. Various examples for such recording schema are provided below.

According to an embodiment disclosed herein, the recorder 102 constantly monitors the inputs received from the sensors 103 and compares the inputs to the settings in the recording schema. In an embodiment, the sensors' 103 inputs may be compared to predefined thresholds (e.g., speed, location, G-force), abnormal measurement (e.g., high heart rate, low heart rate variability), and more.

If it is determined that a recording should start, the recorder 102 selects one or more cameras for recording the segment and sets these cameras according to the settings in the recording schema. Data captured by the cameras 101 is saved in the flash memory. It should be noted that the when data is captured, the recorder 102 continues to monitor the sensors' inputs to determine if recording current active cameras should be stopped, if the setting of the current active cameras should be changed (e.g., change zoom), and addition camera(s) should be activated for the current segment, or if a recording of a new segment should begin.

Once the recording of a current segment is completed, the recorder 102 determines if the segment should be tagged as a “high-interest” segment. Such determination is made based on the value(s) of one or more sensors and according to settings defined in the recording scheme. For example, if the accelerometer sensor shows unexpected motion, the respective segment may be tagged as a high interest segment. In another embodiment, segments can be tagged as “high interest” by a user of the recorder 102 through a user interface. It should be understood that such a recording schema may include adding, subtracting, and/or adjustments to the recording parameters of one or more of the cameras 101.

In yet another embodiment, metadata information can be saved or associated with each segment recorded in the memory. The metadata may include, for example, vehicle information, user's information (e.g., a driver, a trainer, etc.), date and time, weather information, values measured by one or more predefined sensors during the segment, and so on.

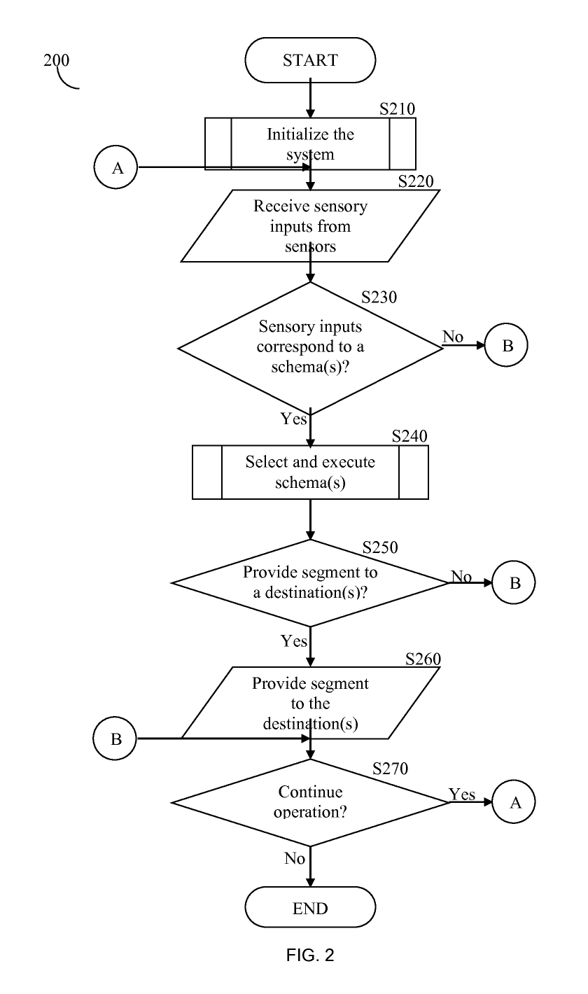

FIG. 2 shows a non-limiting and exemplary flowchart 200 illustrating the operation of the recorder 102 according to an embodiment of the invention. In S210 the recorder 102 is initialized, for example, by providing one or more schemas as discussed above. In S220, the recorder 102 receives sensory information from one or more sensors 103. In S230, it is checked whether the sensory information received is applicable to one or more of the recording schemas loaded to the system 100 upon initialization, and if so, execution continues with S240; otherwise, execution continues with S270.

In S240, one or more of the recording schemas determined to require execution responsive of the sensory inputs received are executed by the recorder 102. It should be understood that the recorder 102 may apply all of the schemas identified as relevant, or, only a portion thereof as determined by the schemas available. For example, it may not be necessary to activate one schema if another schema is to be activated and a hierarchy between schemas may be established. A recording schema defines the operation of each of the cameras 101 responsive of sensory inputs from the one or more of the sensors 103. A recording schema is associated with a certain activity to be captured.

The execution of a recording schema includes operating the one or more cameras 101 to capture the visual/audio data for the activity defined in the schema. For example, the operation of the one or more cameras 101 include starting the recording one or more of the cameras 101 (different cameras 101 may be activated in different times), changing the zoom, and/or recording rate (frames per second) of the cameras 101 during the recording, and so on. Thus, the recorder 102 fully controls the operation of one or more cameras 101 during the recording of a segment based on the sensory information and the rules of the rule schemas.

In S250, it is checked whether information based on the operation of the schema is to be provided, for example, by uploading a segment to a website, as discussed hereinabove in greater detail. If it is necessary to provide such information execution continues with S260; otherwise, execution continues with S270. In S260 information resulting from the schema(s) processing in S240 is provided to the desired target in either a push or pull mechanism, i.e., is actively sent to the desired destination, or made available on the system 100, for example, in memory, for the destination to initiate a process of retrieval of such information on its own initiative. In S270, it is checked if the operation of system 100 should continue, and if so execution continues with S220; otherwise, execution terminates, for example responsive of a shutdown trigger provided to the system 100 and/or a user of the system.

Following are non-limiting examples for the embodiments described above. It should be appreciated, however, that the operation of the system 100 and other embodiments of the invention should not be limited to examples provided below.

In one example, the system 100 is installed in a truck. The cameras include side-door, rear-door, or above-vehicle cameras and the sensors include the like of power-take-off (PTO), proximity sensor, RFID and a RuBee sensors. In such configuration, according this example, the driver stops the vehicle and turns off the engine. According to a recording schema, side-door, rear-door, below-vehicle or above-vehicle cameras begin recording when a signal is received from either a power-take-off (PTO) or proximity sensor that indicates a door has been opened. The recording continues until the PTO sensor indicates the door has been closed. Recording of the open door(s) continues and is coordinated with events that, for example, indicate whether RFID or RUBEE tagged goods have been removed from the vehicle or have been replaced to the vehicle.

Front-facing and in-cab-facing cameras are switched off as the schema determines that these are not necessary under the current conditions. The technician opens a side or rear door of the vehicle, signaling the side or rear-door cameras to be activated. Video recording of the door opening continues and the recording is tagged with time, date and sensory data that is received and associated with the removal or replacement of the RFID, RuBee or proximity-sensor tagged item being removed or replaced.

In another example, the embodiments described herein are implemented in a system that is used for a supply chain application to document goods and products that are carried on a vehicle and have been removed or replaced. Here, the recording schema may define video events, time, date, and sensor information that can be used to trigger a re-supply chain event or to notify technician or supervisor that an item has been forgotten or lost. It may not be necessary to record the good while it is determined that the vehicle is in motion, or otherwise it may be sufficient, according to a specific schema, to merely have a period still photograph of the goods.

Proximity sensors may be used to indicate if a bucket-up condition is sensed or to indicate that tools or equipment stored on the roof of the vehicle have been removed. Proximity sensors trigger respectively the recording by the camera associated with roof-storage area or associated with the operation of the bucket. Below-vehicle video and sensors can indicate if an obstruction is present, or vehicle maintenance event, such as a flat tire, has occurred. When the recorded door opening or proximity sensor receives a door-closed event, a bucket-down event or an object replacement event from the PTO, proximity sensor or identification tag, video recording for the associated camera is stopped.

The recoding schema may also define that when a vehicle is in forward motion two or more cameras may look to the front of the vehicle and at the driver activities (covering hands, wheel, dashboard, face, etc.). When a vehicle is in reverse motion, two or more cameras may look from the rear of the vehicle as well as at the driver activities in the vehicle cabin (covering hands, wheel, dashboard, face, and so on).

Another example and type of sensory input to monitor driver safety is the HRV (Heart Rate Variability) signal and ratio between the sympathetic to parasympathetic power which is known to have a good correlation with driver fatigue. Monitoring HR (Heart Rate) is known and can be done in a variety of ways using either contact or non-contact methods in the car to measure the driver HR. The HRV is also well-known and can be measured easily within a small computerized device such as a smartphone or other similar devices. According to an aspect of the invention, an HR sensor input is used, and as the trend line for driver fatigue is recognized, the recorder 102 triggers the operation of the camera looking at the driver's face and eyes, using in one embodiment an IR camera, to better identify if this is actually a driver fatigue. Using the camera looking out in the driving direction, and the sensors monitoring the vehicle movement, it is established if this is defined as a fatigued driver and if so, the appropriate alarm is generated and action is taken.

A flight training school may use the system with its recording devices on planes, connected to sensors coming from plane instrumentation and engine monitors or mobile sensors independently connected or part of the recorder device. This is another application for the embodiments discussed herein. The sensors include GPS, accelerometers, gyro, compass, as well as others.

Three cameras are mounted in this case in the cockpit looking out over the cowling (Cam1), looking over the shoulder of the student pilot to capture pilot manipulation and instrument panel (Cam2), and a 3rd camera with an Infra Red (IR) option looking at the pilot face (Cam3). Additional cameras may be mounted under the plane body looking at the plane underside and at the retractable wheels (Cam4) and under the two wings looking back to capture wing flaps and covering the back 180 degrees (Cam 5 and Cam 6). An additional camera may be positioned near the runway to capture the landing from a ground view (Cam 7). In this scenario two-to-four cameras operate at a time based on sensory input.

In the above configuration, one or more recording schemas may define how the recorder 102 should operate the various cameras based on the sensory input when a student pilot practicing landings with instrument approaches with an instructor. According to this example, a plane engine starts and plane taxies at a speed above 5 knots for more than 5 seconds resulting in Cam 1 and Cam 2 operation. The plane accelerates for takeoff and when at a speed of over 20 knots for 5 seconds the appropriate schema causes Cam 1, Cam 3, Cam 4, and Cam 5 to operate, while Cam 2 cease operation, until plane levels off and maintains altitude or does not descend at more than 200 feet/minute. At that time Cam 1, Cam 2 and Cam 3 operate while Cam 4 and Cam 5 cease operation according to the appropriate schema. It should be noted that Cam 3 adds the capture of the pilot scanning the instruments.

The first part therefore captures the takeoff and departure with views of the pilot manipulation, centerline of the airstrip and the relative airplane positioning, wheels folding and other points of interest for the IFR (Instrument Flight) student. The second part may include the incoming IFR procedure where Cam 1, Cam 2 and Cam 3 are recording, with Cam 4 added when the wheels out airspeed (say under 100 knots) is reached in descent or when the wheels down button sensor is activated. Finally, at airspeed below 70 knots, Cam 1, Cam 2, Cam 4 and Cam 7 operate and capture the landing. Cam 7 may also be activated by the plane GPS position triggering the ground video camera which transmits a short video segment, for example, wirelessly (WiFi) to the main recorder device. Finally, at a speed of under 40 knots for a period of at least 5 seconds (landing completed), Cam 1 and Cam 2 operate until the plane speed is under 5 knots for more than 5 minutes.

It should be understood that each of these cases describe a schema that is based on the sensory inputs received and triggers the appropriate use of the optical capturing device, for example, a camera, to capture the necessary images in concert with and responsive of the sensory input(s) received. Moreover, additional scenarios and corresponding schemas may be developed without departing from the scope of the invention.

As noted above the system can tag as “high interest” certain segments captured by the recorder. Such tagging may be done respective of a timeline. The tagged points and areas of interest that may be uploaded to a desired location in the web or cloud can then be easily reviewed by directly going to the tagged areas or reviewing only the “areas of interest memory”. This allows a user to avoid the review of lengthy recordings and rather hone on to areas of interest or tagged parts of the activity. Such areas of interest may be automatically annotated by the schema, for example, by an indication such as “loss of altitude beyond boundaries”. A person of ordinary skill in the art will readily appreciate the advantage of such tagging for automatic, self- or assisted debriefing.

The various embodiments disclosed herein can be implemented as hardware, firmware, software, or any combination thereof. Moreover, the software is preferably implemented as an application program tangibly embodied on a program storage unit or non-transitory computer readable medium. The application program may be uploaded to, and executed by, a machine comprising any suitable architecture. Preferably, the machine is implemented on a computer platform having hardware such as one or more central processing units (“CPUs”), a memory, and input/output interfaces. The computer platform may also include an operating system and microinstruction code. The various processes and functions described herein may be either part of the microinstruction code or part of the application program, or any combination thereof, which may be executed by a CPU, whether or not such computer or processor is explicitly shown. In addition, various other peripheral units may be connected to the computer platform such as an additional data storage unit and a printing unit.

All examples and conditional language recited herein are intended for pedagogical purposes to aid the reader in understanding the principles of the invention and the concepts contributed by the inventor to furthering the art, and are to be construed as being without limitation to such specifically recited examples and conditions. Moreover, all statements herein reciting principles, aspects, and embodiments of the invention, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

What is claimed is:

1. A system for monitoring the operation of a vehicle, comprising:
a plurality of sensors;
a plurality of optical capture devices;
a memory in which at least a recording schema is stored, the at least recording schema contains rules for operation of at least one of the plurality of optical capture devices responsive of at least one of the plurality of sensors respective of at least one activity to be captured; and
a recorder coupled to the plurality of sensors, the plurality of optical capture devices and the memory, the recorder determines based on the at least recording schema and responsive of at least an input from at least one of the plurality of sensors which of the at least one of the plurality of optical capture devices to operate.

2. The system of claim 1, further comprising:
a network interface to allow connectivity with at least one web server.

3. The system of claim 2, wherein the recorder stores at least a segment of a recording made by at least one of the plurality of optical capture devices in a flash media card included the recorded, wherein the recorder is further configured to send the segment to the web server.

4. The system of claim 3, wherein the recorder determines based on the at least a schema whether the segment is a segment of high interest, wherein a high interest segment is uploaded to one or more video sharing web site by the web server.

5. The system of claim 1, wherein a sensor from the plurality of sensors is any one of: a motion detector, an acceleration detector, a GPS, a speed detector, a gyro, a position detector, a vital signs detector, a temperature sensor, an engine status sensor, a tire pressure sensor, a rotary motion sensor, and a compass.

6. The system of claim 1, wherein an optical capture device from the plurality of optical capturing devices is any one of: a video camera, a stills camera, and an infrared (IR) camera.

7. The system of claim 6, wherein control of any camera of the video camera, the stills camera, and the infrared (IR) camera includes control of at least one of: shutter speed, frame rate, zoom, resolution, view angle, and optical configuration.

8. The system of claim 1, wherein the vehicle is any one of: a motor car, a motor cycle, a boat, a plane, a glider, a bicycle, a snowmobile and a truck.

9. The system of claim 1, further comprising:
at least another optical capturing device that is independent of the vehicle and communicatively coupled to the recorder such that the recorder can activate the at least another optical capturing device responsive of at least an input from at least one of the plurality of sensors.

10. The system of claim 1, wherein the recorder is configured to operate the at least one optical capturing device by at least one of: starting visual and audio capturing by the at least optical capturing device, changing zoom of the at least optical capturing device, changing recording rate of the at least optical capturing device; and stopping the visual and audio capturing by the at least optical capturing device.

11. A method for determining operation of a plurality of optical capturing devices mounted on a vehicle, comprising:
receiving sensory inputs from a plurality of sensors mounted on the vehicle;
determining which of a plurality of recording schemas stored in memory are to be activated responsive to at least an input from the sensory inputs;
operating at least an optical capturing device based at least on a determined recording schema from the plurality of recording schemas, wherein a recoding schema contains rules for operation of at least one of the plurality of optical capture devices responsive of at least one of the plurality of sensors respective of at least one activity to be captured; and
recording at least an information segment by the at least an optical capturing device responsive of the determined schema.

12. The method of claim 11, further comprising:
operating at least another optical capturing device that is independent of the vehicle responsive of at least an input of the sensory inputs.

13. The method of claim 11, further comprising:
determining if the at least a segment is of high interest and if so sending such at least a segment over a communication link to at least a web server.

14. The method of claim 13, further comprising:
marking the at least segment by tagging a respective timeline of the at least a segment.

15. The method of claim 11, operating the at least one optical capturing device includes at least one of: starting visual and audio capturing by the at least optical capturing device, changing zoom of the at least optical capturing device, changing recording rate of the at least optical capturing device; and stopping the visual and audio capturing by the at least optical capturing device.

16. The method of claim 11, wherein a sensor from the plurality of sensors is any one of: a motion detector, an acceleration detector, a GPS, speed detector, a gyro, a position detector, a vital signs detector, a temperature sensor, an engine status sensor, a tire pressure sensor, a rotary motion sensor, and a compass.

17. The method of claim 11, wherein an optical capture device from the plurality of optical capturing devices is any one of: a video camera, a stills camera, and an infrared (IR) camera.

18. The method of claim 17, wherein control of any camera of the video camera, the stills camera, and the infrared (IR) camera includes control of at least one of: shutter speed, frame rate, zoom, resolution, view angle, and optical configuration.

19. The method of claim 11, wherein the vehicle is any one of: a motor car, a motor cycle, a boat, a plane, a glider, a bicycle, a snowmobile and a truck.

20. A computer software product embedded in a non-transient computer readable medium containing instructions that when executed on the computer perform a process for determining operation of a plurality of optical capturing devices mounted on a vehicle, comprising:
receiving sensory inputs from a plurality of sensors mounted on the vehicle;
determining which of a plurality of recording schemas stored in memory are to be activated responsive to at least an input from the sensory inputs;
operating at least an optical capturing device based at least on a determined recording schema from the plurality of recording schemas, wherein a recoding schema contains rules for operation of at least one of the plurality of optical capture devices responsive of at least one of the plurality of sensors respective of at least one activity to be captured; and
recording at least an information segment by the at least an optical capturing device responsive of the determined schema.
